(19) United States
(12) Patent Application Publication
(10) Pub. No.: US 2008/0295549 A1
(43) Pub. Date: Dec. 4, 2008

(54) Multi-functional burglar-proof lockset assembly structure

(76) Inventor: Chen-Kuei Hsieh, Jhongli City (TW)

Correspondence Address: Troxell Law Office Pllc, Suite 1404, 5205 Leesburg Pike, Falls Church, VA, 22041, US

(21) Appl. No.: 11/806,079

(22) Filed: May 29, 2007

(51) Int. Cl. B60R 25/02; E05B 65/12

(52) U.S. Cl. 70/57.1

(57) ABSTRACT

A multi-functional burglar-proof lockset assembly structure is composed a lockset, an alarm system, a chargeable and dischargeable battery, and a solar energy panel. The lockset body can be locked on a wheel ring of a steering wheel to restrict rotation, and at a same time the alarm system in the lockset is activated to proceed with detection of frequency change of reflected ultrasonic wave, detection of abnormal fracture of glass, and preventive detection of ultrasonic signals, through a detection end and a central processing unit. In a same time, the solar energy panel is used to transform sunlight into electric energy which is stored by the chargeable and dischargeable battery, enabling the burglar-proof lockset to solve trouble of dismantling the lockset when the electric power is insufficient and to save cost of replacement.

### BACKGROUND OF THE INVENTION

(a) Field of the Invention

The present invention relates to a multi-functional burglar-proof lockset assembly structure, and more particularly to a multi-functional burglar-proof lockset assembly structure which is provided with a solar energy panel for transforming sunlight into electric energy which is then stored by a chargeable and dischargeable battery.

(b) Description of the Prior Art

Many people are now configuring a vehicular burglar-proof lockset for their cars to reduce possibility of being stolen. Most of the vehicular burglar-proof locksets are sophisticated and provided with multi-functional alerting devices, with electric power of which being supplied by an ordinary battery. Therefore, as a lifetime of usage of the battery is low, a number of times for replacement are also increased. Furthermore, as the ordinary battery needs to be replaced when its electric power is exhausted, the lockset should be dismantled to facilitate thee replacement of the battery. As a dismantling operation is actually a laboring and time consuming procedure, cost and time for the replacement are wasted.

### SUMMARY OF THE INVENTION

The primary object of present invention is to provide a multi-functional burglar-proof lockset assembly structure, especially a lockset assembly structure having a solar energy panel for transforming sunlight into electric energy which is then stored by a chargeable and dischargeable battery, so as to solve trouble of dismantling the burglar-proof lockset when the power is insufficient, and to save the cost of replacement.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows another perspective view of the present invention.

FIG. 3 shows a system block diagram of the present invention.

FIG. 4 shows a schematic view of an embodiment of the present invention.

FIG. 5 shows a second schematic view of an embodiment of the present invention.

### DETAILED DESCRIPTION OF THE PREFERRED EMBODIMENTS

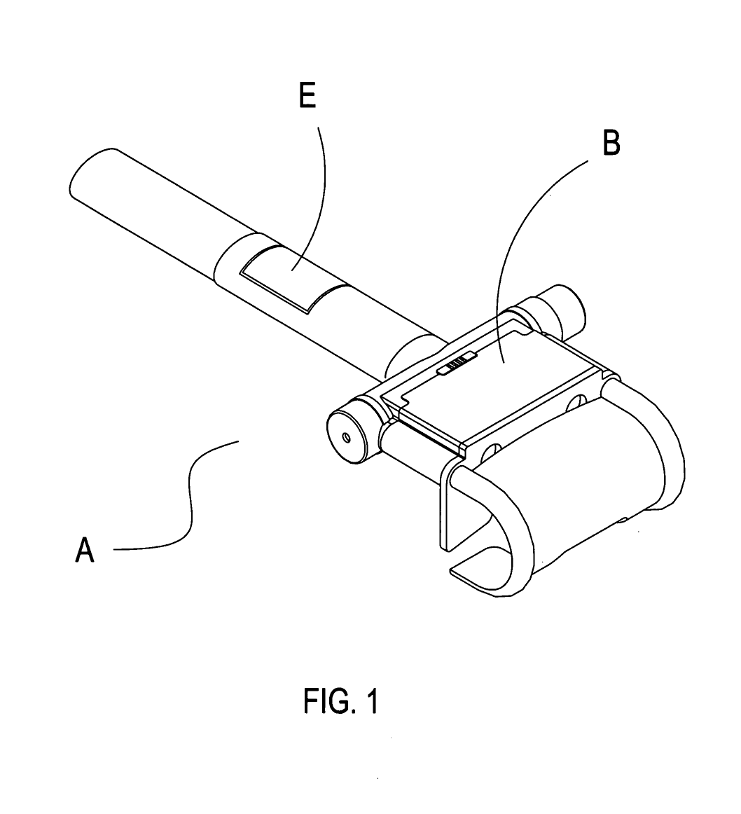

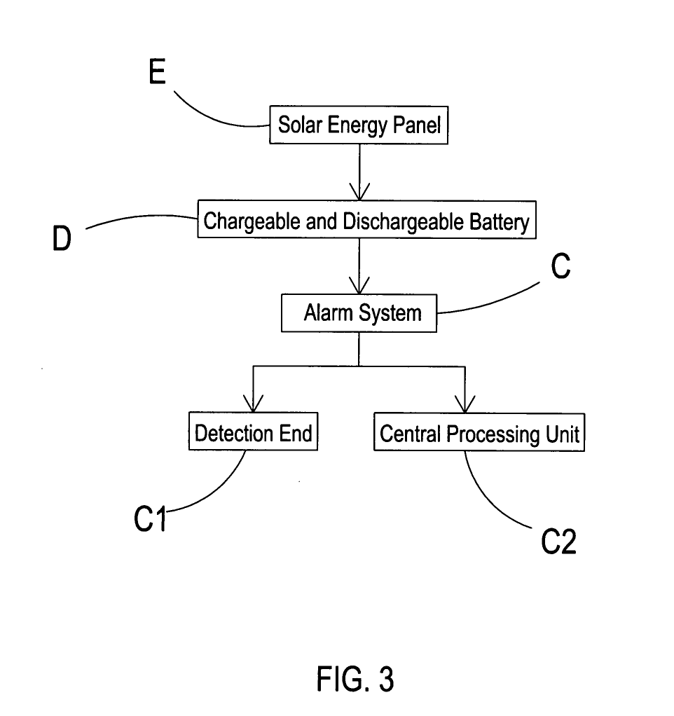

The present invention is to provide a multi-functional burglar-proof lockset assembly structure. Referring to FIGS. 1 to 3, a burglar-proof lockset A comprises primarily a lockset B, an alarm system C, a chargeable and dischargeable battery D, and a solar energy panel E. An interior of the lockset B is provided with the alarm system C which is disposed with a detection end C1 and a central processing unit C2 to proceed with detection of frequency change of reflected ultrasonic wave, detection of abnormal fracture of glass, and preventive detection of ultrasonic signals. The alarm system C is connected to the chargeable and dischargeable battery D which is conducted with the solar energy panel E to transform sunlight into electric energy that is then stored by the chargeable and dischargeable battery D, thereby enabling the burglar-proof lockset A to solve trouble of dismantling the lockset when the electric power is insufficient, and to save cost of replacement simultaneously.

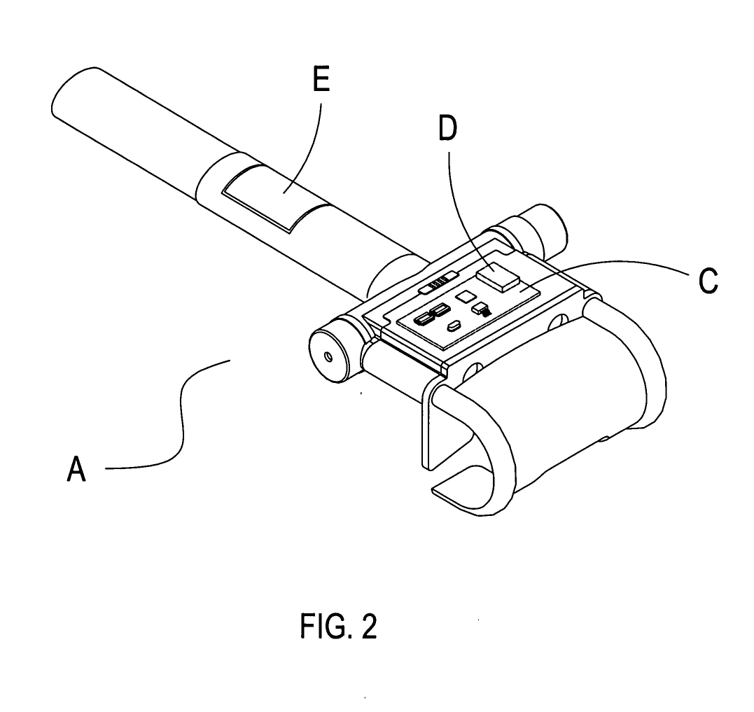

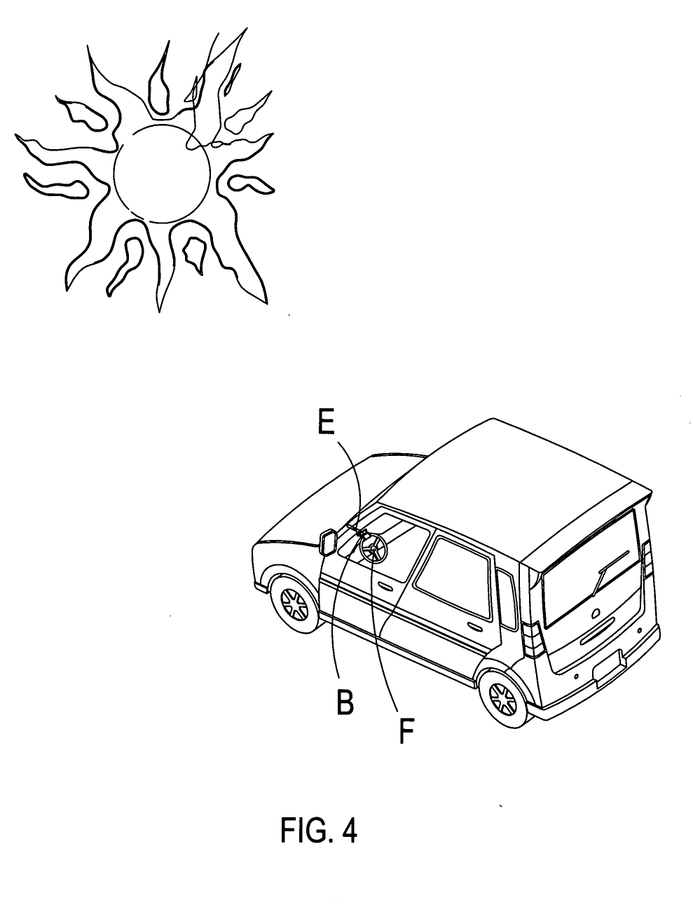

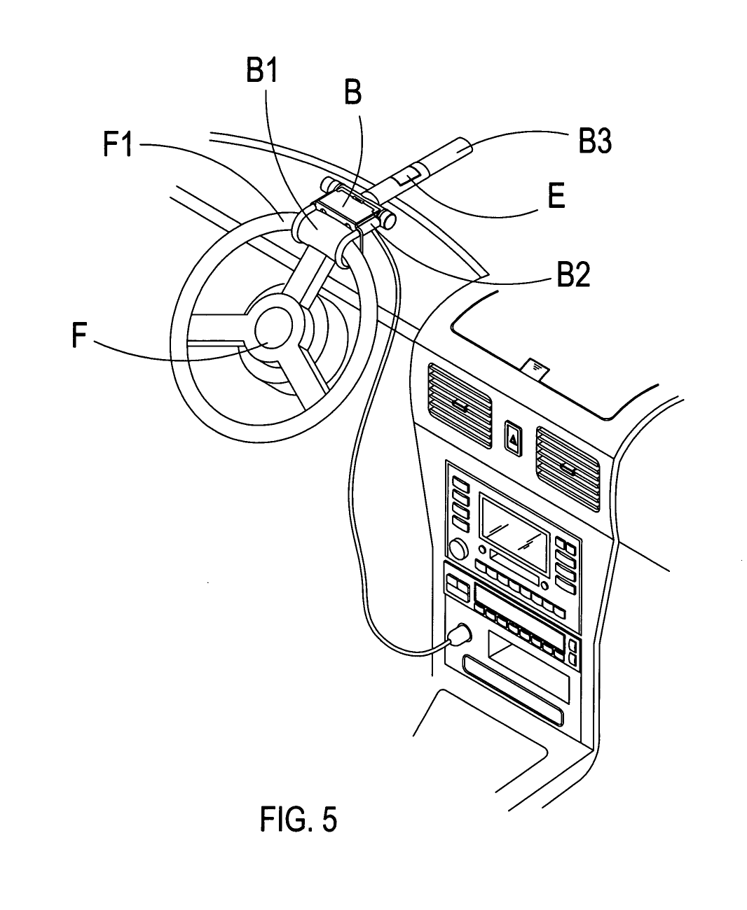

Referring to FIGS. 2, 3, 4, and 5, when the burglar-proof lockset A is to be locked on a steering wheel F for carrying out a burglar-proof alert function, a locking sheath B1 is sheathed on a wheel ring F1 of the steering wheel F and is locked at a locking seat B2; whereas, a rod B3 of a lockset B is extended onto a driving panel, enabling the burglar-proof lockset A to be locked on the steering wheel F to restrict rotation of the steering wheel F and to burglar-proof and secure a car. When the solar energy panel E is irradiated by sunlight, the sunlight is transformed into electric energy which is stored by the chargeable and dischargeable battery D through electric connection, thereby facilitating the alarm system C to acquire the required power. In addition, by transforming the sunlight into the electric energy by the solar energy panel E which is then stored through the chargeable and dischargeable battery D, the trouble of dismantling the lockset B when the electric power is insufficient can be solved by the burglar-proof lockset A, and the cost of replacement can be saved. If the chargeable and dischargeable battery D cannot be charged through the solar energy panel E, it can be charged through an external charging connector, or a vehicular charging connector. Furthermore, the alarm system C can communicate with a user by transmitting signals through a communication interface or a personal alerting device, thereby achieving a burglar-proof alert function.

In order to further manifest the advancement and the practicability of the present invention, the advantages thereof are listed below:

1. It can save the trouble of dismantling the lockset.

2. It can reduce the cost of replacement.

3. It can save time and cost.

4. It can supply the required power in multiple ways.

5. It is provided with industrial competitiveness.

6. It is provided with the value of commercial exploitation.

7. It is provided with the novelty.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multi-functional burglar-proof lockset assembly structure, wherein the burglar-proof lockset includes a lockset, an alarm system, a chargeable and dischargeable battery, and a solar energy battery; an interior of the lockset being provided with the alarm system which is used to detect a situation that a car is stolen and to transmit signals; the alarm system being connected with a chargeable and dischargeable battery which is conducted with a solar energy panel for transforming sunlight into electric energy that is stored by the chargeable and dischargeable battery, thereby enabling the burglar-proof lockset to solve trouble of dismantling the lockset when the electric power is insufficient, and to save cost of replacement.

2. The multi-functional burglar-proof lockset assembly structure according to claim 1, wherein the alarm system communicates with a user by transmitting signals through a communication interface.

3. The multi-functional burglar-proof lockset assembly structure according to claim 1, wherein the alarm system communicates with a user by transmitting signals through a personal alerting device.

4. The multi-functional burglar-proof lockset assembly structure according to claim 1, wherein the alarm system is activated in corresponding to locking of the lockset, thereby achieving a burglar-proof alert function.

5. The multi-functional burglar-proof lockset assembly structure according to claim 1, wherein the alarm system further includes a detection end and a central processing unit to proceed with detection of frequency change of reflected ultrasonic wave, detection of abnormal fracture of glass, and preventive detection of ultrasonic signals.

6. The multi-functional burglar-proof lockset assembly structure according to claim 1, wherein the chargeable and dischargeable battery is further conducted by an external charging connector or a vehicular charging connector, to achieve an object of charging.
